(19) United States
(12) Patent Application Publication
(10) Pub. No.: US 2023/0198043 A1
(43) Pub. Date: Jun. 22, 2023

(54) BATTERY MODULE FOR LOCOMOTIVE

(71) Applicant: STEWART & STEVENSON LLC, Houston, TX (US)

(72) Inventors: Mike BECK, Pflugerville, TX (US); Tyler KIEFER, Round Rock, TX (US); Ryan LOOFS, Leander, TX (US); Mike SIMMONS, Austin, TX (US); Michael WARHUS, Leander, TX (US)

(21) Appl. No.: 18/073,766

(22) Filed: Dec. 2, 2022

Related U.S. Application Data
(60) Provisional application No. 63/291,132, filed on Dec. 17, 2021.

(51) Int. Cl. H01M 10/63; H01M 50/204; H01M 50/249; H01M 50/264; H01M 50/242; H01M 10/625; H01M 10/658

(52) U.S. Cl. CPC H01M 10/63; H01M 50/204; H01M 50/249; H01M 50/264; H01M 50/242; H01M 10/625; H01M 10/658; H01M 2220/20

(57) ABSTRACT

An energy storage system comprising a battery row having first and second row ends, first and second end pieces abutting the first and second row ends, respectively, an end piece retaining strap encircling the end pieces and the batteries therebetween and applying a first compressive force thereto, thereby defining a battery assembly, the battery assembly having external corners, first and second foam pieces enclosing at least the external corners of the battery assembly; a foam retaining strap encircling the foam pieces so as to maintain the foam pieces in a desired position relative to the battery assembly, thereby defining a battery module, and an enclosure having at least one battery module retained inside the enclosure. The foam pieces may be configured to reduce or enhance the rate of heat flow between the batteries and the operating environment.

### CROSS-REFERENCE TO RELATED APPLICATIONS

This application is a nonprovisional application which claims priority from U.S. provisional application No. 63/291,132, filed Dec. 17, 2021, which is incorporated by reference herein in its entirety.

### TECHNICAL FIELD/FIELD OF THE DISCLOSURE

The present disclosure relates to a battery pack in which a plurality of battery cells are packaged for use in a locomotive.

### BACKGROUND OF THE DISCLOSURE

Modern locomotives may be equipped with systems for automatically starting and stopping their engines when one or more conditions exist. Locomotives typically also include low-power equipment such as air conditioning, controls, lights, and security systems, however, and it may be desirable to provide power to that equipment when the locomotive engine is not running. Traditional lead acid batteries tend to have insufficient capacity to adequately power such loads for a sufficient time period.

### SUMMARY

In some embodiments, an energy storage system comprises a plurality of batteries arranged in a row, the row having first and second row ends; first and second end pieces abutting the first and second row ends, respectively; an end piece retaining strap encircling the first and second end pieces and the batteries therebetween and applying a first compressive force thereto, thereby defining a battery assembly, the battery assembly having external corners; first and second foam pieces enclosing at least the external corners of the battery assembly; a foam retaining strap encircling the first and second foam pieces so as to maintain the first and second foam pieces in a desired position relative to the battery assembly, thereby defining a battery module; and an enclosure. At least one battery module may be retained inside the enclosure.

The at least one battery module may be retained inside the enclosure by a latch member that applies a second compressive force to the battery module. The second compressive force may be less than the first compressive force. The latch member may releasably engage an attachment fixture on the enclosure. The latch member may comprise first and second members. The first and second members may be pivotably connected, whereby the latch member defines a latch plane.

The end piece retaining strap may define a first plane, the foam retaining strap may define a second plane, and the first plane, the second plane, and the latch plane may all be mutually orthogonal.

At least one end piece may include one or more, or in some embodiments at least three, features selected from the group consisting of high voltage terminals, clip sites, pass-through mounting holes, internally threaded openings, and cleat sites. In some embodiments, at least one end piece may include a high voltage terminal, a clip site, a pass-through mounting hole, an internally threaded opening, and a cleat site.

The at least one end piece may include a high voltage terminal and the high voltage terminal may be molded into the end piece during manufacture of the end piece. The at least one end piece may include two high voltage terminals and the high voltage terminals may be molded into the end piece during manufacture of the end piece.

At least one end piece may have an inner face and an outer face and at least one of the inner and outer faces may include at least one open cell structure. The open cell structure may be a honeycomb structure, the at least one face may include a plurality of honeycomb structures, and the honeycomb structures extend across at least 25% of the area of the at least one face.

The batteries may each have an axis of operational expansion and the batteries may be aligned such that their operational expansion axes align with the first compressive force.

The first and second foam pieces may each comprise a material having a UL 94 V-0 rating. The first and second foam pieces may be electrically insulating. The first and second foam pieces may or may not completely encapsulate the battery assembly. The system may further include a thermal management system in thermal contact with the battery assembly. The first and second foam pieces may have a predetermined thermal conductivity that is selected based in part on an expected ambient temperature and in part on a target battery operating temperature.

The enclosure may have a direction of travel and the enclosure may further include at least one crumple zone aligned along with the battery module along the direction of travel.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1 and 2 are isometric elevation views, respectively of a power unit according to an embodiment of the present disclosure.

FIG. 3 is a perspective view of a battery module according to an embodiment of the present disclosure.

FIG. 4 is an isometric view of an end piece according to an embodiment of the present disclosure.

FIG. 5 is a side view of the end piece of FIG. 4.

FIG. 6 is an elevation view of the end piece of FIG. 4, showing the opposite side as FIG. 4 and with a high voltage terminal inserted into the end piece.

FIGS. 7 and 8 are cross-sections taken along lines 7-7 and 8-8, respectively, of FIG. 6.

FIG. 9 is an exploded view of a battery module according to an embodiment of the present disclosure with the foam retaining straps removed.

FIG. 10 is a perspective view of a latch member according to an embodiment of the present disclosure.

FIG. 11 is an illustration showing a battery module in accordance with the present disclosure engaging a cleat bar.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

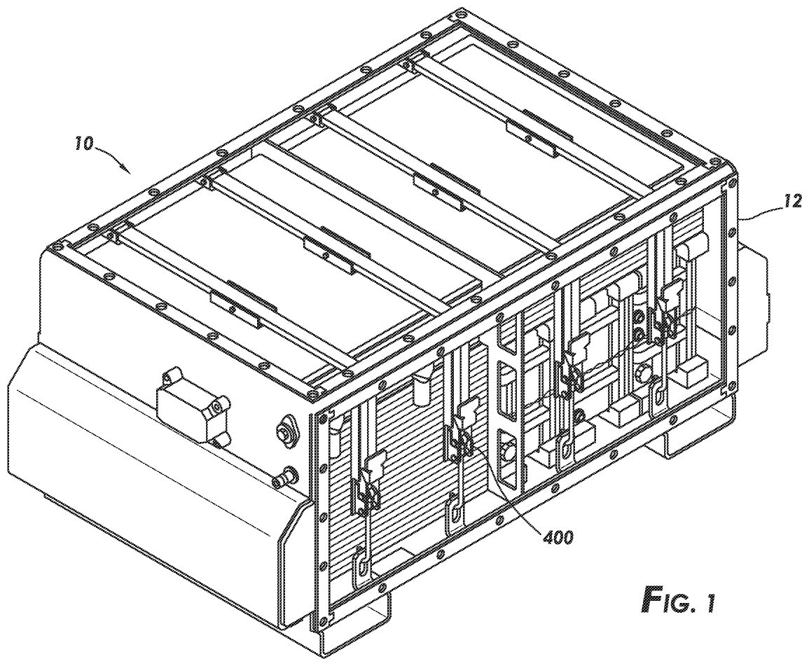

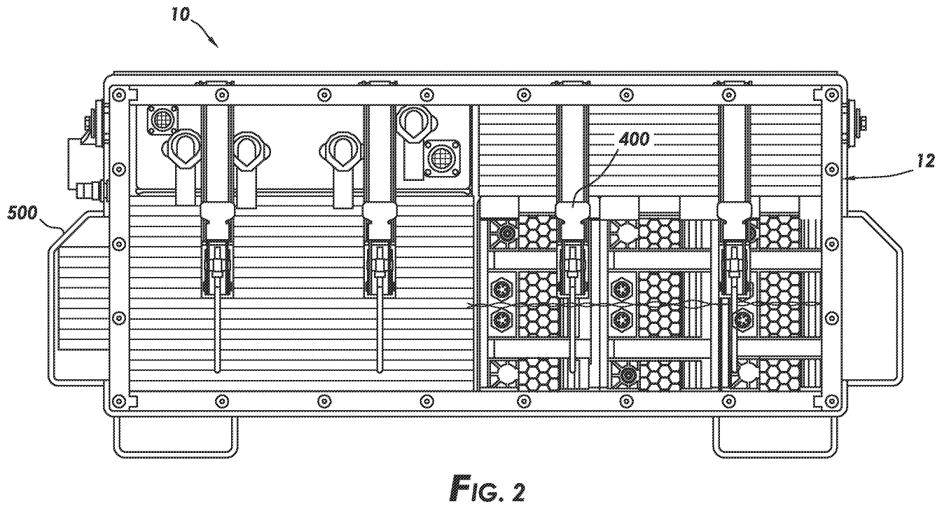

Embodiments of the invention include a power unit and the components thereof. Referring initially to FIGS. 1 and 2, a power unit 10 may include an enclosure 12, and one or more battery modules 100 enclosed therein. One or more latch assemblies 400, described below, may be coupled to the enclosure and serve to retain the battery module(s) 100 therein. Batteries 110 may comprise lithium-ion batteries, in which case battery modules 100 and enclosure 12 provides structural protection impact and vibration during operation and/or transit.

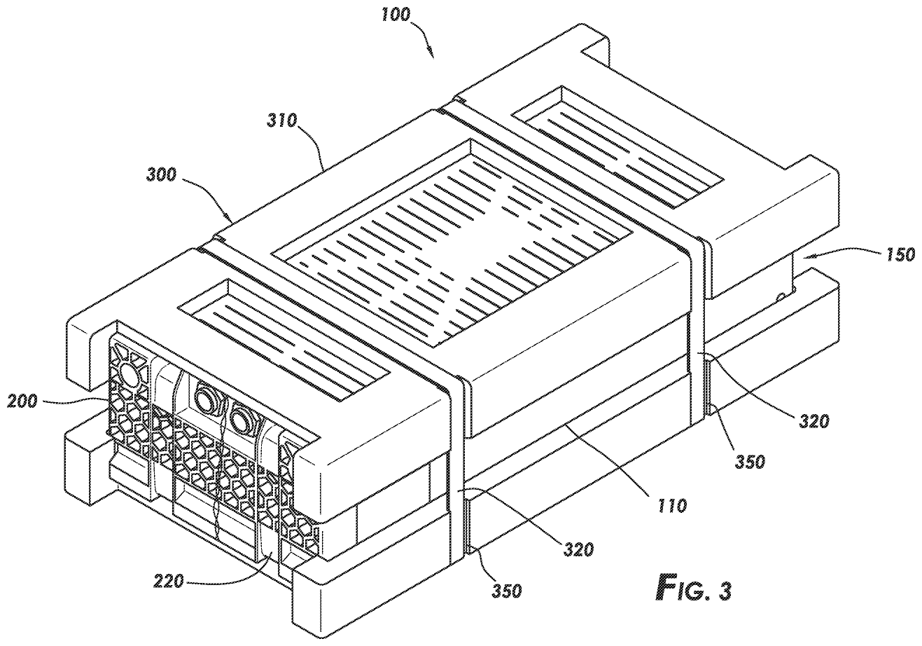

Referring now to FIG. 3, a battery module 100 is shown outside of enclosure 12. In some embodiments, a battery module may comprise at least one battery 110. Battery 110 may comprise a single battery, a row of two or more batteries, and in some embodiments twelve batteries. Batteries 110 may be disposed between a pair of end pieces 200. The battery assembly 150 comprising batteries 110 and end pieces may be held together by one or more straps 220 or mechanical fasteners may be used to secure inner housing 155 to end pieces 200. A pair of foam members 300 is secured around the battery assembly by one or more foam retaining straps 320 to form battery module 100.

Lithium-ion battery cells may tend to expand during operation. If uncontrolled swelling is allowed, the swelling can result in accelerated degradation of the cells, causing a reduction in product lifespan. Thus, preventing excessive expansion by containing the battery(ies) in a rigid structure can increase battery life. Depending on the configuration of the cell, expansion may not be isotropic and may be primarily along one axis. In the case of cylindrical cells, most of the swelling force is transmitted perpendicular to the radial axis in all radial directions, rather than through the flat faces at the ends of the cylindrical cell. As described below, end pieces 200 are configured to abut and bear on batteries 110 so as to minimize expansion. Each end piece 200 may also provide an interface for various connections to the module. As discussed in more detail below, interface features may include one or more inset high voltage terminal(s), thin wall features for the installation of clip-on fasteners, bulkhead pass-through mounting holes for the installation of electrical and/or fluid connectors, internally threaded features by which auxiliary components may be affixed to the module, and cleats or other mating features by which the module may be secured within a larger system.

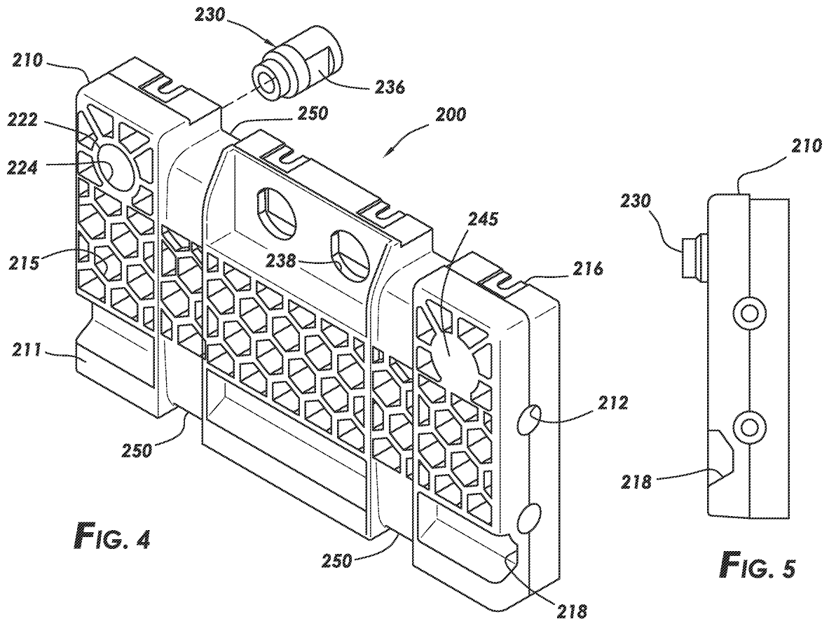

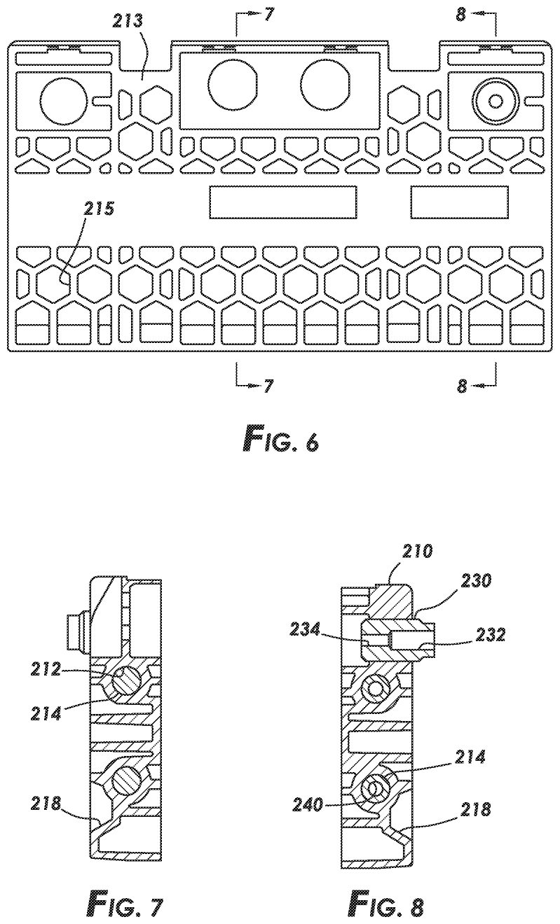

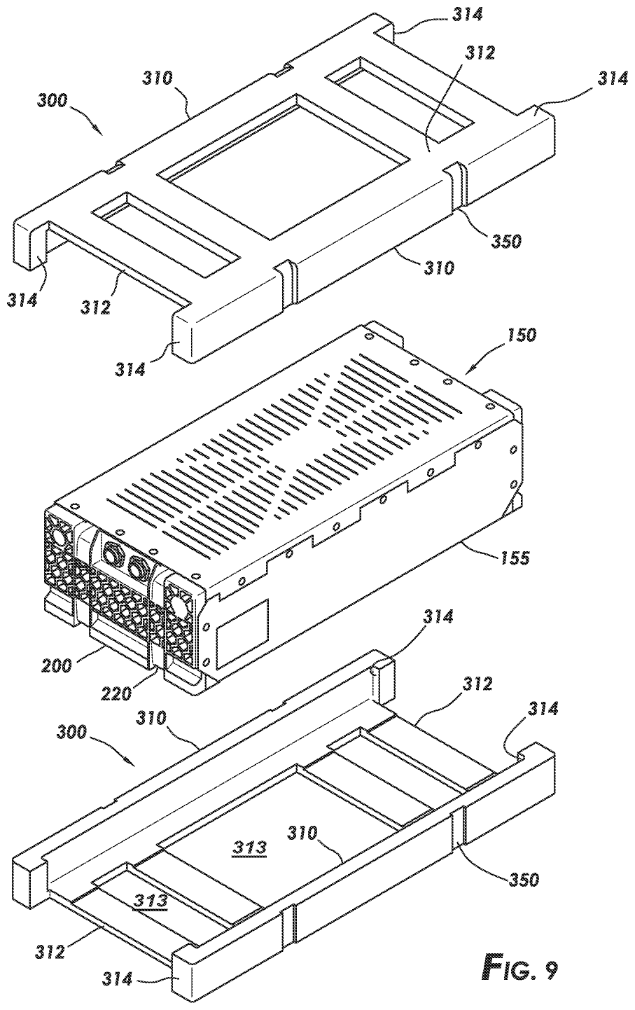

As shown in FIGS. 4-8, each end piece 200 may have a substantially planar body 210 with a plurality of features included thereon. In some embodiments, body 210 may comprise a molded plastic element reinforced with one or more inset metal inserts. In some embodiments, body 210 may comprise any suitable, strong, lightweight material, which may comprise a composite material. The composite may be a polymer/glass-fiber composite. By way of example only, glass fiber may comprise from 0%-30% of the composite by weight. Polymers such as PC-ABS blends, PBT, or nylon can be used. In some embodiments a suitable composite comprises 20% glass-filled nylon. Body 210 may have a width W and height H that are substantially equal to the width and height, respectively, of a battery 110. Body 210 may have an outer face 211 that faces away from batteries 110 and an inner face 213 that abuts and bears on an adjacent battery 110. One or more optional spacers may be included between inner face 213 and battery 110. Body 210 may have a thickness T that is calculated to provide a desired degree of stiffness to body 210. Body 210 may include a plurality of open cell structures 215 whose axes are normal to faces 211, 213. Open cell structures 215 may be honeycomb structures with a generally hexagonal shape or may be any other desired shape or shapes. Triangular cells may be used instead if compressive strength in the transverse plane is desired. Open cell structures 215 may extend across at least 5%, at least 10%, or in some embodiments at least 25%, 30%, or 40% of the area of each face 211, 213. Open cell structures 215 serve to increase the stiffness of body 210 so as to resist deflection caused by expansion of the battery cells during normal operation. In the illustrated embodiment, open cell structures 215 do not extend all the way through body 210, but in other embodiments, open cell structures 215 may extend all the way through body 210. In order to achieve a desired degree of stiffness in end piece body 210, various combinations of mechanical rib structures, of which honeycomb structures are one example, and stiffening inserts may be selected.

Body 210 may include a plurality of clip sites 216, which may comprise portions of body 210 that are adapted to receive clip-on hardware. Clip sites 216 may comprise tabs, slots, eyes, or the like and may include thin-wall sections that facilitate attachment of clips thereto. Clip sites 216 are shown spaced along the upper (as drawn) face of body 210 but could be located anywhere on body 210. Body 210 may further include one or more cleat sites 218. Cleat sites 218 may comprise inset portions of outer face 211. Referring briefly to FIG. 11, a battery module is shown in engagement with a first cleat bar 156. By way of example only, first cleat bar 156 may be fixed in place, and battery assembly 150 slid into alignment such that first cleat bar 156 engages cleat sites 218 on a first end of the battery assembly 150. Once the module engages first cleat bar 156, a second cleat bar 158 may be installed by positioning it such that the battery module is firmly in the desired position.

Referring again to FIG. 4, body 210 may further include at least one high voltage (HV) terminal site 222. HV terminal site 222 may comprise a bore 224 extending through the thickness of body 210 and sized to receive an HV terminal 230. Body 210 may also include one or more pass-through mounting holes 238 for the installation of electrical and/or fluid connectors.

As best seen in FIGS. 4 and 8, HV terminal 230 may be generally cylindrical, with a central bore 232, a reduced diameter portion 234 at one end, and at least one notch or face 236 in its outer surface. One or both ends of HV terminal 230 may include threads. HV terminal(s) 230 may be configured to provide a high-voltage electrical connection to a terminal bolt, lug, or cable to/from batteries 110. HV terminal(s) 230 may comprise electrically conductive metal or alloys including such metals as copper, aluminum, zinc, or brass and may be molded into body 210 during the manufacturing of body 210. Notch 236 may help prevent movement or dislodgement of HV terminal 230 relative to body 210. In the illustrated embodiment, end piece 200 has one HV terminal 230 molded therein and a second potential HV terminal location 245 is a dummy (molded closed). In other embodiments, the positions of the HV terminal 230 and the dummy 245 may be reversed. In still other embodiments, body 210 may be provided with two HV terminals and no dummy.

As best seen in FIGS. 4, 5, and 8, body 210 may include at least one transverse bore 212 therethrough. Each bore 212 extends the full width of body 210 and is sized to receive a rod 214. Rods 214 may be constructed of metal, composite, or plastic, may be solid or hollow, and may be molded into body 210 during the manufacturing of body 210. The outer surface of each rod may be knurled or provided with other features that help prevent movement of each rod relative to body 210. One or both ends of each rod may include internal threads 240 for securing tooling plate or heating/cooling elements thereto. Rods 214 serve to stiffen end piece 200 and help resist deflection caused by expansion of the battery cells during normal operation.

In some embodiments, end pieces 200 include at least one strap guide 250, best shown in FIG. 4, which may be a notch, groove, or other feature that facilitates positioning of end piece retaining straps 220 around battery assembly 150. During manufacturing, a desired number of batteries 110 may be aligned between two end pieces 200 and one or more end piece retaining straps 220 may encircle battery assembly 150, positioned in strap guide(s) 250. In the illustrated embodiment, two end piece retaining straps 220 are provided. Tension may be applied to each end piece retaining strap 220 before it is secured, so as to apply a compressive force to the battery assembly 150. To that end, end piece retaining straps 220 may be constructed of hardened steel or other suitable material having a desired tensile strength. In some embodiments, battery assembly 150 may be constructed such that end piece retaining straps 220 provide a desired level of compressive force that is calculated to be sufficient to prevent expansion of the batteries 110 therein. While the illustrated embodiment shows end pieces 200 positioned at the ends of a single row of batteries 110 and end piece retaining straps 220 exerting force in a direction parallel to the longitudinal axis of the row, other configurations of batteries 110, end pieces 200, and end piece retaining straps 220 are contemplated.

By the inclusion of the aforementioned features, end pieces 200 provide structural containment, electrical isolation, and mechanical coupling sites within a single component.

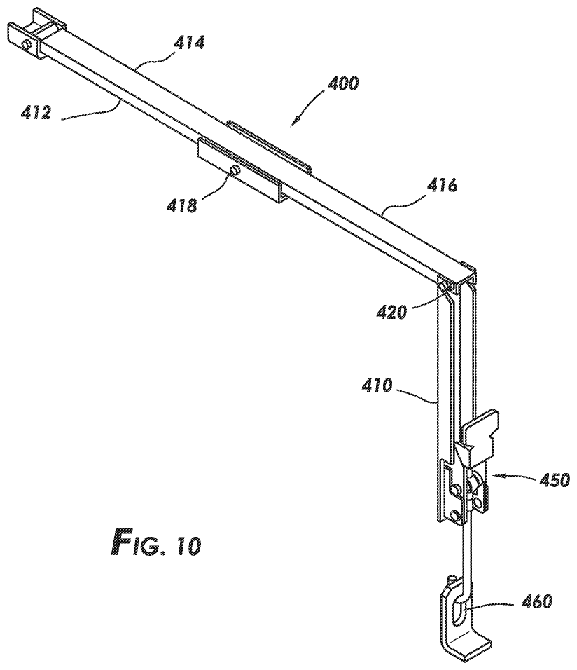

As shown in FIG. 9, each foam member 300 may comprise a pair of longitudinally extending corner sections 310 connected by a plurality of webs 312. Each corner member has a substantially L-shaped cross-section and a corner enclosure 314 at each end. Foam member 300 may be configured such that the space defined between the four corner enclosures 314 can snugly receive a desired number of batteries 110 and a pair of end pieces 200 without substantial deformation or extra space. Webs 312 span the width of the battery module 100 between corner sections 310. The openings 313 between adjacent webs 312 provide air flow. In some embodiments a single web 312 may span the length of battery assembly 150, so that there are no openings along the upper or lower faces of the battery assembly 150. Foam members 300 may likewise be configured so that they contact each other around the circumference of battery assembly 150. The thermal conductivity and configuration of foam members 300 may be adjusted to allow a desired rate of heat absorption from the batteries 110 by the atmosphere. In some embodiments, an inner housing 155 may be included around battery assembly 150 before foam members 300 are added to battery module 100. Inner housing 155 may comprise plates of metal, composite, or other suitable material. Inner housing 155 may provide rigidity to battery assembly 150.

In some embodiments, the portion of the outer surface of battery assembly 150 that is covered by foam members 300 is determined using a calculation that takes into account the projected ambient and operating temperatures for batteries 110 so as to reduce the amount of heat that needs to be removed by a cooling system. In some embodiments, foam members 300 may be constructed such that battery assembly 150 is encapsulated therein. As used herein, “encapsulated” means wholly enclosed. By way of example, if the ambient temperature of the environment in which power unit 10 is to operate is greater than the target operating temperature of the batteries, encapsulating battery assembly 150 in foam may reduce the rate of heat absorption from the atmosphere by the batteries 110, thereby reducing the amount of heat that needs to be removed by a cooling system. By way of another example, if the ambient temperature of the environment in which power unit 10 is to operate is less than the target operating temperature of the batteries, the thermal conductivity and openings 313 in foam members 300 may be optimized to allow a maximum rate of heat absorption from the batteries 110 by the atmosphere while ensuring a desired mechanical functionality, thereby reducing the amount of heat that needs to be removed by a cooling system.

In some embodiments, each foam members 300 may include at least one strap guide 350, which may be a notch, groove, or other feature that facilitates positioning of foam retaining straps 320 around foam members 300. During manufacturing, a desired number of battery assemblies 150 may be aligned between two foam members 300 and one or more foam retaining straps 320 may encircle battery assembly 150, positioned in a strap guide 350 in each foam member 300. In the illustrated embodiment, two foam retaining straps 320 are provided. While the embodiment illustrated in FIG. 3 shows a single battery assembly 150 captured between a pair of foam members 300 and foam retaining straps 320 extending in a direction transverse to the longitudinal axis of battery assembly 150, other configurations of battery assembly 150, foam members 300, and foam retaining straps 320 are contemplated. Likewise, while the illustrated embodiment includes two foam retaining straps 320, other means can be used to retain foam members 300 adjacent to battery assembly 150. For example foam members 300 can be held in their respective positions by connecting them to each other and/or to battery assembly 150 using adhesive, brackets, fasteners, or the like, by frictional engagement with battery assembly 150, or some combination thereof. In some embodiments, the retention of foam members 300 is sufficient that battery module 100 can be easily transported and installed as a unit.

In some embodiments, all or some of the steps of assembling battery modules 100 may be automated. By way of example only, the application of end piece retaining straps 220 and/or foam retaining straps 320 may be automated or carried out by an autonomous device.

One of the greatest issues with lithium-ion battery cells is a risk of thermal runaway, where the rate of heat generation within a cell exceeds the rate at which heat can be removed, resulting in combustion of the cell. While various preventative measures can be used to proactively detect and/or prevent the occurrence of thermal runaway, there is still a need for measures that will mitigate the effects of a thermal runaway event. Some embodiments of foam members 300 may comprise a foam having one or more of the following properties: UL 94 V-0 rating or better, melting temperature at least 130° C., thermal conductivity 0.05 W/(mK) or less, electrically insulating, Young's modulus between 75 and 500 N/m². In some embodiments, foam members 300 may comprise a semi-porous UL94-V0 EPP foamed material that allows vapors released during a lithium-ion battery cell fire to escape while simultaneously providing limited containment of the flames generated during a thermal runaway event by slowing heat transfer to adjacent modules and/or other nearby components within the system.

Foam members 300 provide thermal and electrical insulation to battery modules 100 and their constituent battery cells 110. In the event of exposure to an external flame and/or heat source, the foam will act to slow the spread of heat into and through batteries 110 so that the cell temperatures may continue to be controlled within a safe range through active thermal management. For example, if the energy storage system includes a closed-loop coolant circulation system, the rate of coolant circulation may be increased when sensors detect a fire or thermal runaway in one or more batteries 110. If the excess heat can be kept away from the unaffected batteries, it may be possible to limit damage resulting from the event. Without the presence of the insulating foam material to slow the rate of heat transfer from an external source into other batteries 110, it is more likely that the thermal management system would be overwhelmed and unable to reject heat at a sufficient rate to prevent thermal runaway.

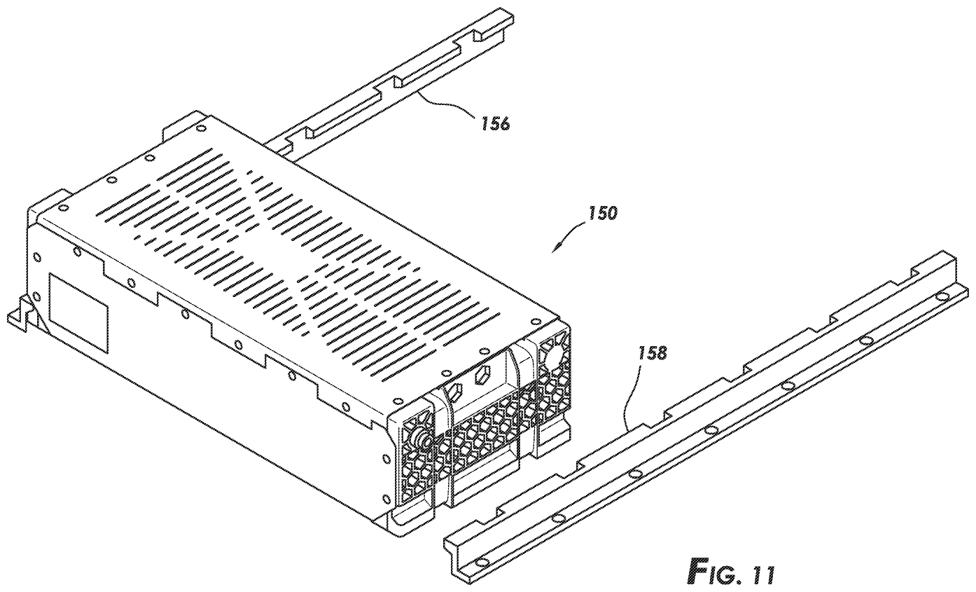

Referring now to FIG. 10, in some embodiments, battery module 100 may be secured to a support or enclosure by one or more latch assemblies 400. Latch assembly 400 may comprise a first arm 410, a second arm 412, a primary hinge 420 connecting first and second arms 410, 412, and a latch 450. First and second arms 410, 412 define a latch plane. Primary hinge 420 allows first and second arms 410, 412 to rotate relative to each other in the latch plane. Second arm 412 may comprise left and right arm elements 414, 416 joined by a secondary hinge 418. Secondary hinge 418 allows left and right arm elements 414, 416 to rotate relative to each other in the latch plane. One end of left arm element 414 may be connected to secondary hinge 418. The opposite end of left arm element 414 may be releasably mechanically coupled to a designated attachment fixture on the support or enclosure. One end of right arm element 416 may be connected to secondary hinge 418. The opposite end of right arm element 416 may be connected to primary hinge 420. In some embodiments, latch 450 serves to releasably connect latch assembly 400 to a designated attachment fixture on the support or enclosure 12 such as eye 460 (shown detached from enclosure 12). Latch 450 may be any means for releasable mechanical coupling. In some embodiments latch 450 includes a mechanism for applying a tensile force to first arm 410, thereby applying a compressive force to the upper surface of a battery module 100. Latch 450 may be a draw latch, compression latch, toggle clamp, ratcheted winch, or other means for releasable mechanical coupling.

Referring again to FIGS. 1 and 2, a plurality of battery modules 100 may be provided within an enclosure 12. A plurality of latch assemblies 400 may be used to retain equipment, including battery modules 100, within enclosure 12. If desired, applying a tension force via latch 450 may cause latch assemblies 400 to apply compressive force in the latch plane to battery modules 100. In some embodiments, enclosure 12 may be sized to fit a pre-existing space and may therefore enclose more volume than is required by the battery module(s) 100 disposed therein. Any volume within enclosure 12 that is not occupied by battery modules 100 may be used for other equipment, including but not limited to a thermal management system, control units, insulation, packing, telemetry and communications devices, a battery management system, and serviceable components such as fuses and contactors. In some embodiments, one or more crumple or crush zones 500 may be included within or adjacent to enclosure 12. Zone 500 may be designed to plastically deform so as to absorb impact energy that would otherwise affect battery modules 100. Thus, if enclosure 12 is expected to be used on a vehicle that has a normal direction of travel, such as a trailer or locomotive, zone(s) 500 may be positioned at the front and/or rear of enclosure 12.

As set out herein, lithium-ion battery cells are susceptible to catastrophic thermal runaway failures caused by puncture, gouging, and/or impact. The present system includes a packaged battery system that provides greater protection of the constituent battery cells than is typically provided by a rigid structural enclosure alone while simultaneously avoiding the addition of significant weight & cost for internal protections. The system includes a cost-effective means of rigidly securing sensitive battery equipment while achieving shock and vibration damping for rugged applications. As an ancillary benefit, the present system provides thermal insulation that reduces the impact of environmental conditions on internal battery temperatures, thereby improving thermal management (i.e., heating & cooling) efficiency.

What is claimed is:

1. An energy storage system, comprising:
a plurality of batteries arranged in a row, the row having first and second row ends;
first and second end pieces abutting the first and second row ends, respectively;
an end piece retaining strap encircling the first and second end pieces and the batteries therebetween and applying a first compressive force thereto, thereby defining a battery assembly, the battery assembly having a plurality of external corners;
first and second foam pieces enclosing at least each external corner of the battery assembly;
a foam retaining strap encircling the first and second foam pieces so as to maintain the first and second foam pieces in a desired position relative to the battery assembly, thereby defining a battery module; and
an enclosure;
wherein at least one battery module is retained inside the enclosure.

2. The system of claim 1 wherein the first and second foam pieces are configured such that one of the following is true:
if an expected ambient temperature of an environment in which the energy storage system is to operate is greater than a target operating temperature of the batteries, the first and second foam pieces encapsulate the battery assembly; and
if an expected ambient temperature of an environment in which the energy storage system is to operate is less than a target operating temperature of the batteries, the first and second foam pieces are optimized to allow a desired rate of heat flow from the batteries by the environment.

3. The system of claim 2 wherein at least one battery module is retained inside the enclosure by a latch member that applies a second compressive force to the battery module and wherein the second compressive force is less than the first compressive force.

4. The system of claim 3 wherein the latch member releasably engages an attachment fixture on the enclosure.

5. The system of claim 3 wherein the latch member comprises first and second members and wherein the first and second members are pivotably connected, whereby the latch member defines a latch plane.

6. The system of claim 5 wherein the end piece retaining strap defines a first plane, wherein the foam retaining strap defines a second plane, and wherein the first plane, the second plane, and the latch plane are all mutually orthogonal.

7. The system of claim 2 wherein at least one end piece includes at least three features selected from the group consisting of high voltage terminals, clip sites, pass-through mounting holes, internally threaded openings, and cleat sites.

8. The system of claim 7 wherein at least one end piece includes a high voltage terminal, a clip site, a pass-through mounting hole, an internally threaded opening, and a cleat site.

9. The system of claim 7 wherein the at least one end piece includes a high voltage terminal and wherein the high voltage terminal is molded into the end piece during manufacture of the end piece.

10. The system of claim 7 wherein the at least one end piece includes two high voltage terminals and wherein the high voltage terminals are molded into the end piece during manufacture of the end piece.

11. The system of claim 2 wherein at least one end piece has an inner face and an outer face and wherein at least one of the inner and outer faces includes at least one open cell structure.

12. The system of claim 11 wherein the open cell structure is a honeycomb structure, wherein the at least one face includes a plurality of honeycomb structures, and wherein the honeycomb structures extend across at least 25% of the area of the at least one face.

13. The system of claim 2 wherein the batteries each have an axis of operational expansion and wherein the batteries are aligned such that their operational expansion axes align with the first compressive force.

14. The system of claim 2 wherein the first and second foam pieces comprise a material having a UL 94 V-0 rating.

15. The system of claim 2 wherein the first and second foam pieces have a predetermined thermal conductivity that is selected based in part on an expected ambient temperature and in part on a target battery operating temperature.

16. The system of claim 15 wherein the first and second foam pieces are electrically insulating.

17. The system of claim 2, further including a thermal management system in thermal contact with the battery assembly.

18. The system of claim 1 wherein the enclosure has a direction of travel, further including at least one crumple zone aligned along with the battery module along the direction of travel.

19. A method for assembling an energy storage system, comprising the steps of:
a) providing a plurality of batteries arranged in a row, the row having first and second row ends;
b) providing first and second end pieces abutting the first and second row ends, respectively;
c) encircling the first and second end pieces and the batteries therebetween with an end piece retaining strap and adjusting the end piece retaining strap so that it applies a first compressive force to the batteries, whereby a battery assembly is defined, the battery assembly having a plurality of external corners;
d) positioning first and second foam pieces so that at least each external corner of the battery assembly is enclosed in foam;
e) encircling the first and second foam pieces with a foam retaining strap so as to maintain the first and second foam pieces in a desired position relative to the battery assembly, whereby a battery module is defined.

20. The method of claim 19, further including one of the following steps before step b):
i) if an expected ambient temperature of an environment in which the energy storage system is to operate is greater than a target operating temperature of the batteries, configuring the first and second foam pieces the first and second foam pieces encapsulate the battery assembly; and
ii) if an expected ambient temperature of an environment in which the energy storage system is to operate is less than a target operating temperature of the batteries, configuring the first and second foam pieces so as to allow a desired rate of heat flow from the batteries by the environment.
